(19) United States
(12) Patent Application Publication
(10) Pub. No.: US 2012/0055188 A1
(43) Pub. Date: Mar. 8, 2012

(54) ICE CUBE TRAY AND LIFTER

(75) Inventor: Mark Levie, Ross, CA (US)

(73) Assignee: Mark Levie, Ross, CA (US)

(21) Appl. No.: 13/224,740

(22) Filed: Sep. 2, 2011

Related U.S. Application Data
(60) Provisional application No. 61/379,492, filed on Sep. 2, 2010.

(51) Int. Cl. F25C 1/04; A23G 9/22; F25C 5/02

(52) U.S. Cl. 62/340; 249/70

(57) ABSTRACT

A combination ice cube tray and ice cube lifter includes a tray having a plurality of openings and a lifting device. The tray has one or more recesses, each of which has a bottom wall and side walls that extend upwardly from and contiguously around the bottom wall for forming one or more ice cubes therein. The lifting device has a base portion and a top member. The base portion includes one or more cradles configured to seat within the one or more recesses of the tray to seat against the bottom wall of each of the one or more recesses of the tray. Each of the one or more cradles is coupled to an upstanding member. The top member couples to the upstanding members. A method for lifting ice cubes from a tray is also disclosed.

### CROSS-REFERENCE TO RELATED APPLICATION

This application claims priority to U.S. Provisional Application No. 61/379,492, filed on Sep. 2, 2010, now expired.

### FIELD

The technology described herein relates to an ice cube tray having a lifting device for removing ice cubes from the tray.

### BACKGROUND

Older techniques for lifting ice cubes from a tray are known. One example utilized a removable, grid-like member positioned inside a rectangular tray, with the grid-like member having a handle that could be rotated upwardly in order to move the transverse separators of the grid in order to break the ice cubes. U.S. Pat. No. 2,619,807 to Ezba describes a lifter for use with an ice cube tray, which used lifting plates that were positioned under several rows of cubes and were coupled to the handle. When the handle was rotated to break the ice, the lifting plates also served to lift several rows of ice cubes in order to make it easier for the user to remove the cubes from the tray.

Another lifting device was taught in U.S. Pat. No. 7,665,711 to Marchionda, which included rotatable members that were positioned in each opening of the ice cube tray. The rotatable members had a contour similar to the contour of each cube mold and were rotatable within each mold to lift each ice cube individually.

### SUMMARY

In accordance with the teachings described herein, a combination ice cube tray and ice cube lifter is provided.

### BRIEF DESCRIPTION OF THE DRAWINGS

FIG. 1 is a perspective view of an example combination ice cube tray and lifting device;

FIG. 2 depicts a top view of the ice cube tray of FIG. 1;

FIG. 3 depicts a side view of the ice cube tray of FIG. 1;

FIG. 4 depicts an end view of the ice cube tray of FIG. 1;

FIG. 5 depicts a side view of the lifting device of FIG. 1;

FIG. 6 depicts a top view of the lifting device of FIG. 1;

FIG. 7 depicts an end view of the lifting device of FIG. 1;

FIGS. 8A-8D depict various a cross-sectional views of the example combination showing the lifting device being positioned inside the ice cube tray; and

FIG. 9 is a schematic view of an ice cube sitting on one of the cradles of the lifting device of FIG. 1.

### DETAILED DESCRIPTION OF THE DRAWINGS

The technology described herein relates generally to an ice cube lifting device 10 for use in an ice cube tray 20. The lifting device seats within an ice cube tray and when it is pulled upwardly, it lifts all the ice cubes 22 out of the tray simultaneously. The example lifting device 10 is shown in combination with an accompanying ice cube tray 20. While it is anticipated that the ice cube tray 20 and lifting device 10 would be sold and marketed together, it is also possible that ice cube lifting devices 10 could be sold separately from the ice cube tray 20. Thus, it is anticipated that the lifting device 10 could be used with any conventional ice cube tray, provided that it fits within the recesses 24 defined within the tray 20.

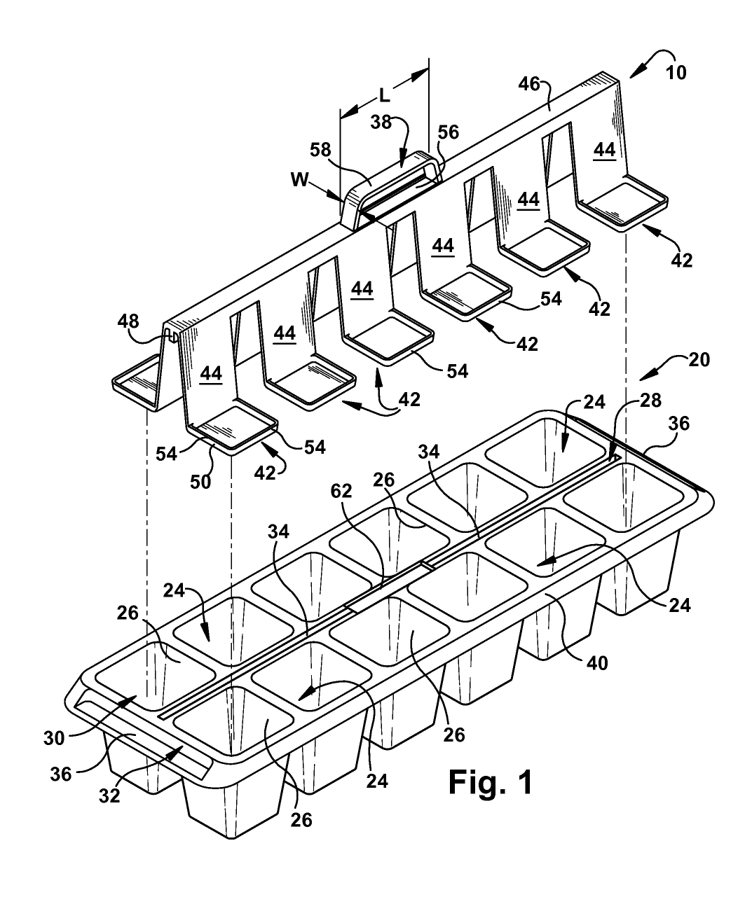

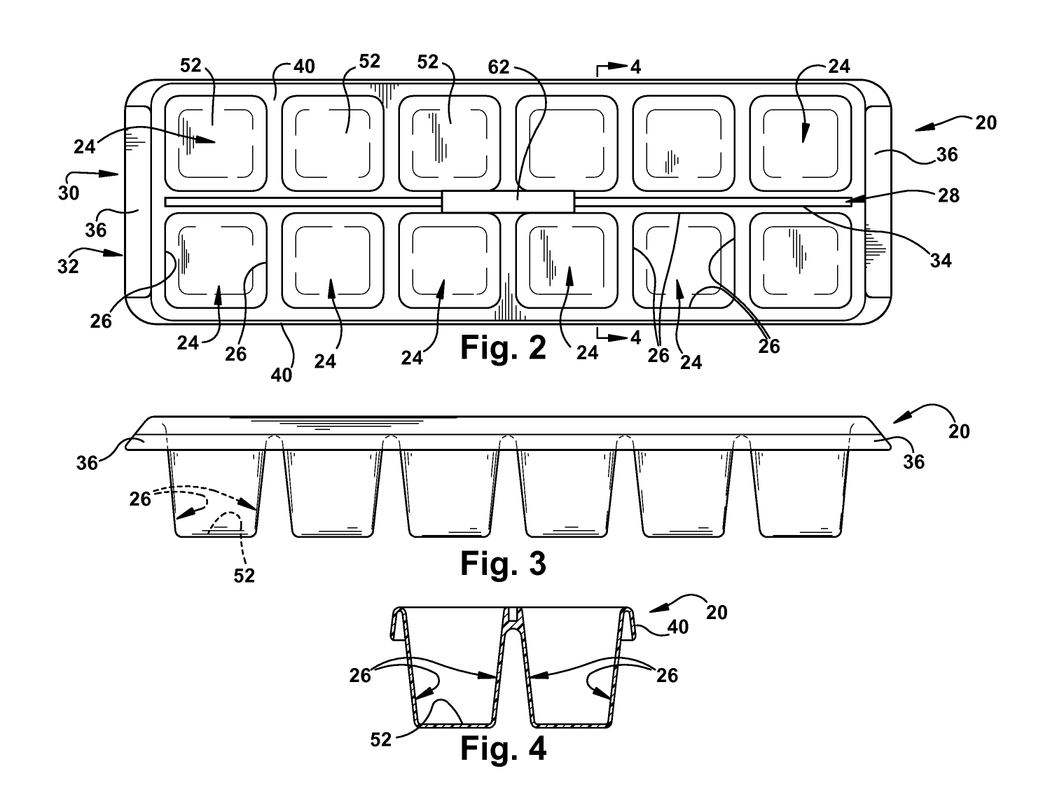

FIG. 1 depicts the example combination of a lifting device 10 and ice cube tray 20. The ice cube tray 20 is somewhat conventional in that it includes a plurality of recesses 24 for forming ice cubes 22 therein. The recesses 24 are separated by walls 26 and a center divider 28 is positioned longitudinally down the center of the ice cube tray 20 in order to separate a first row of ice cubes 30 from a second row of ice cubes 32. The center divider 28 can be a flat connecting member (not shown), or can be a connector that has a longitudinally extending recessed rib/channel section 34, as shown. Handles 36 may be positioned at either end of the ice cube tray 20. FIGS. 2-4 depict various views of the ice cube tray 20. The ice cube tray 20 includes a longitudinally extending opening 34 that is positioned substantially in the center of the center divider 34. As will be discussed below, the opening 34 is sized in order to accept the size of a handle 38 of the lifting device 10. A lip 40 is provided around the edge of the ice cube tray 20 in order to provide stability to the tray 20. The lip 40 extends downwardly around the periphery of the tray 20.

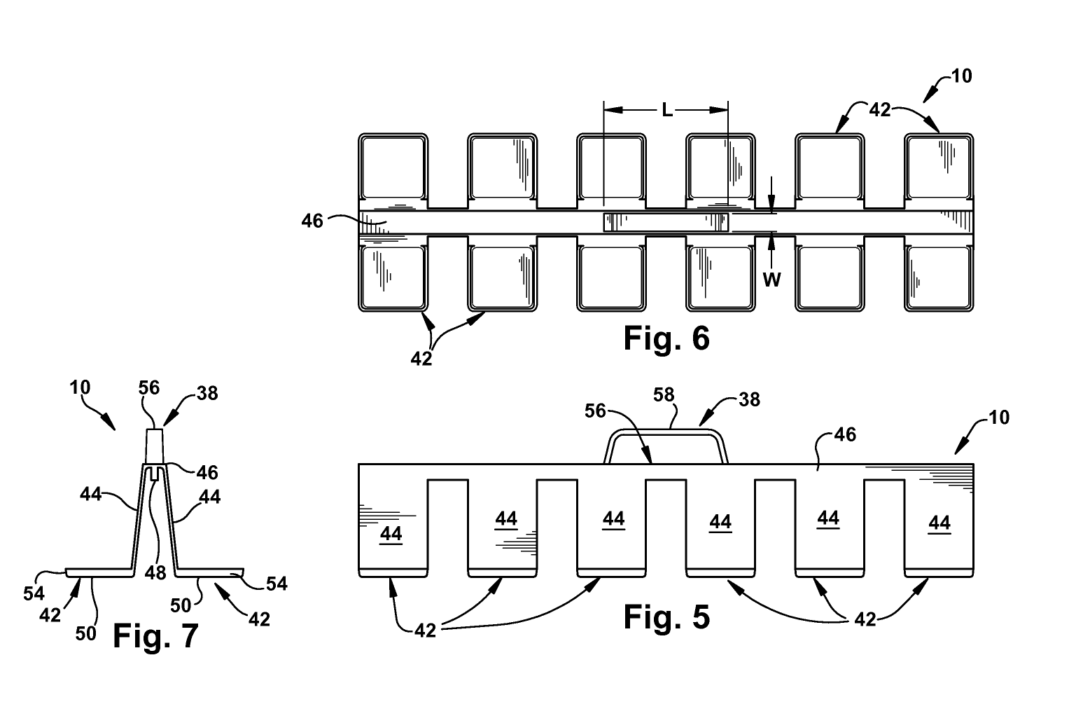

The example lifting device 10, shown in FIGS. 1 and 5-7, includes a plurality of cradles 42 and a plurality of upstanding members 44. An upstanding member 44 is coupled to each cradle 42. The upstanding members 44 are joined together by a central portion 46 that extends along the length of the lifting device 10. The central portion 46 is substantially flat and positioned in a parallel plane to the cradles 42. The central portion 46 has a downwardly extending rib portion 48 that assists in strengthening the central portion 46. The tray 20 has a complimentary recess 34 for accepting the rib 48, which assists in stabilizing the lifting device 10 on the ice cube tray 20.

The cradles 42 have a flat bottom surface 50 for seating against a bottom surface 52 defined in the ice cube tray recesses 24. The cradles 42 have short, upwardly extending walls 54 to assist in cradling an ice cube when the lifting device 10 is removed from the ice cube tray 20. The upstanding members 44 are substantially vertically oriented and are angled at a slightly greater than 90 degree angle relative to the cradle bottom surface 50. Because of this angle, the spacing between the cradles 42 along the center line is greater than the width of the central portion 46. A handle 38 is formed along the central portion 46 substantially in the center thereof. An opening 56 is positioned under the handle 38. The handle 38 extends upwardly from the central portion 46 and has a flat top surface with angled side walls. The opening 56 under the handle 38 is larger in length L than the length of the top surface 58 of the handle 38 and larger in width than the width W of the handle 38.

The cradles 42 have a shape such that they can seat snugly within each recess 34 of the ice cube tray 20. In addition, the angle of the upstanding member 44 of each cradle 42 has an angle that substantially corresponds with an angle of the inner wall 26 of each recess 34 so that the upstanding member 44 of each cradle 42 seats snugly against the inner wall 26 of each recess 24 of the ice cube tray. It is preferred that the cradle 42 and upstanding member 44 seat snugly against the surfaces of the ice tray 20 such that liquid can not flow underneath the surfaces of the cradle 42 of the lifting device 10, although this is not critical to the invention. Even if some space were provided between the bottom surface 50 of the cradle 42, the upstanding members 44, and the interior walls 26 of the ice cube tray 20, the lifter 10 could still be used to remove ice cubes 22 from the tray 20. The cradles 42 shown are substantially square, but could be other shapes, such as rectangular, round, oval, triangular, or any shape, including novelty shapes, if desired.

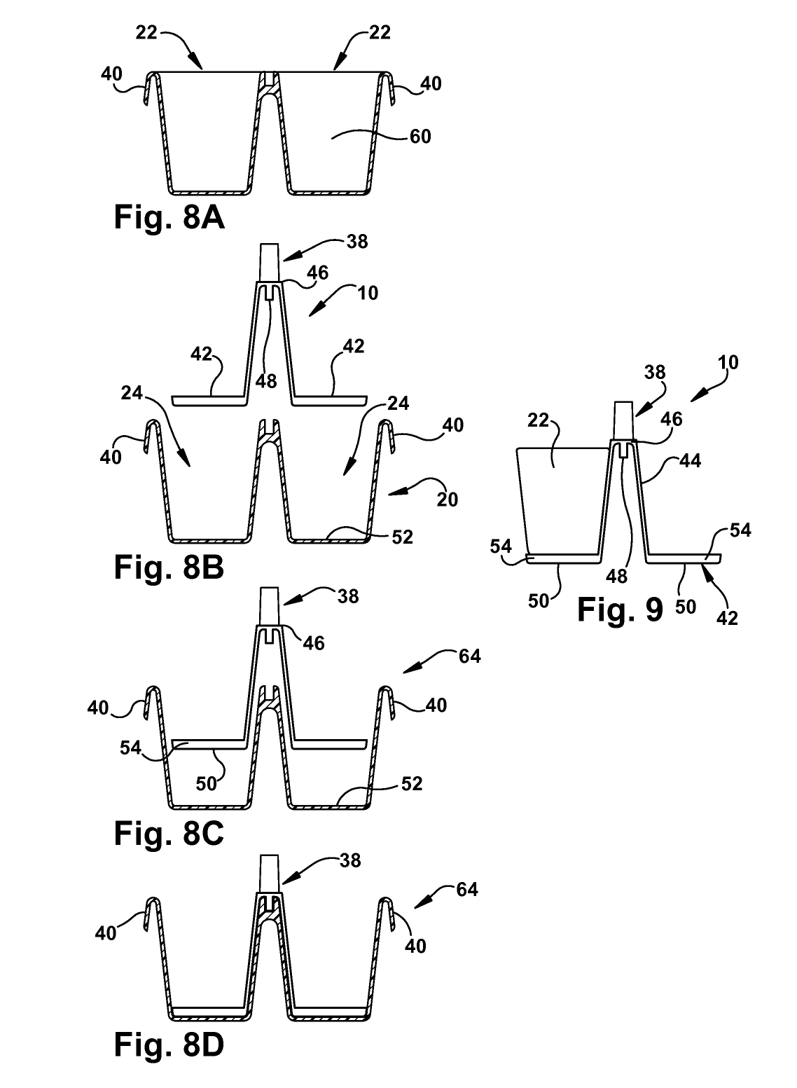

FIGS. 8a, 8b, 8c, and 8d each depict an example of positioning the lifting device 10 in the ice cube tray 20 and shows how the lifting device 10 seats in the tray 20. FIG. 8a depicts an ice cube tray 20 filled with a liquid 60 without the lifting device 10 positioned in the tray 20. The ice cube tray 20 can be used independently of the lifting device 10. FIG. 8b shows the lifting device 10 positioned over the recesses 24 within the tray 20. FIG. 8c shows the lifting device 10 positioned so that it is partially inserted into the recesses 24. FIG. 8d shows the lifting device 10 when it is fully inserted into the ice cube tray 20. As is evident, the downwardly extending rib 48 of the lifting device 10 seats within the channel 34 defined in the center divider 28 of the tray.

FIG. 9 depicts an ice cube 22 positioned on a cradle of the lifting device 10. A longitudinally extending opening 62 in the center divider 28 ice cube tray 20 is sized to accept a handle 38 of a lifting device 10 when ice cube trays 20 are stacked on top of each other. The ice cube trays 20 are shaped so that one tray 20 will sit on top of another tray 20. The handle 38 of the lifting device 10 is inserted through the longitudinal opening 62 of the overlying ice cube tray 20 and a tray 20 seats on the central portion 46 of the lifting tray such that the rib 48 of the central portion 46 of the lifting tray 10 mates with the recessed channel 34 of the tray. The longitudinal opening 62 in the ice cube tray center divider 28 allows for ice cube trays 20 to be stacked along with their corresponding lifting devices 10. Stacking the trays 20 provides for more space within a freezer compartment since the combined lifter/ice cube trays 64 can be stacked on top of each other. Multiple combination trays/lifters 64 can be stacked on top of each other.

The tray and lifting device 64 can be made of any material that is useful for ice cube trays 20, including plastic materials and metal materials. While the trays shown include twelve recesses 24 for forming ice cubes 22, more or less than 12 cubes 22 could be formed in a single tray. Any manufacturing technique known to those of skill in the art can be utilized.

While the cradles are shown with a solid bottom surface, bottom surfaces with openings could be used to manufacture the ice cube tray and lifting device. While the cradles are described as having side walls, the side walls are not required and the cradles could alternatively be provided by a flat member with no side walls. The flat member would seat against the bottom of the ice cube tray. It is envisioned that the cradle could be a loop-type member that fits against the bottom of the tray and would lift the ice cube from the tray when the lifting device is lifted upwardly. More than one lifting device could be positioned in a try at a time, if desired, so that only part of the ice cubes would be lifted at a time.

The ice cube tray 20 and lifting device 10 could be made of any desired material. One type of material that can be utilized is polyethylene. The ice cube tray and lifting device could be made of different materials, for example.

A combination ice cube tray and ice cube lifter includes a tray and a lifting device. The tray has one or more recesses, each of which has a bottom wall and side walls that extend upwardly from and contiguously around the bottom wall for forming one or more ice cubes therein. The lifting device has a base portion and a top member. The base portion includes one or more cradles configured to seat within the one or more recesses of the tray to seat against the bottom wall of each of the one or more recesses of the tray. Each of the one or more cradles is coupled to an upstanding member. The top member couples to the upstanding members.

The base portion includes a plurality of cradles and the tray includes a plurality of recesses, with each cradle being coupled to an upstanding member. The top member joins the upstanding members together. The top member includes a handle and the upstanding members are wall portions. The upstanding wall portions are spaced from one another to define a longitudinal space therebetween, with the cradles being arranged in two rows and being spaced apart by the longitudinal space between the upstanding wall portions, and the recesses in the tray defining two rows that correspond in position with the spacing of the cradles. The base portions of the lifting device may be configured to seat snugly against and around the bottom wall of each recess within the tray such that liquid will not substantially flow under the base portions when the recesses are filled with a liquid.

The tray may include a center divider positioned between the two rows of recesses, with an opening extending through the center divider. The opening is positioned at a point along the length of the tray that corresponds to the position of the handle of the lifting device.

A plurality of trays may be provided and a corresponding plurality of lifting devices may be provided, with a lifting device being coupled to each tray such that each tray/lifting device combination is stackable upon another tray/lifting device combination. The handle of the adjacent lifting device may extend through the opening disposed in the adjacent tray such that the tray/lifting device combinations are stackable on top of each other. A strengthening rib may be positioned under the top member. The tray may have a center divider with a longitudinally extending channel. The channel may be sized to accept the rib when devices are stacked on top of each other.

The top member of the lifting device may have a width and a length. The tray center divider may have a width and a length that is substantially similar to that of the lifting device. The width of the top member of the lifting device is wide enough to support an adjacent tray should the tray be positioned on the top member. The upstanding members of the lifting device may be substantially separated from each other until they mate with the top member.

A method for lifting ice cubes from a tray includes providing a tray having a plurality of recesses, each of which has a bottom wall and upstanding side walls for forming an ice cube in each recess. The method also includes providing a lifting device having a plurality of cradles for seating against the bottom wall of each of the plurality of recesses and an upstanding member coupled to each cradle, said upstanding members being joined together at the top end thereof and forming a handle. The method further includes positioning the lifting device in the recesses such that the cradles fit snugly within each recess, filling the recesses with a fluid, freezing the fluid in the trays, and raising the lifting device out of the tray utilizing the handle to remove the ice cubes that are formed on each cradle.

An ice cube lifting device for use with an ice cube tray having a plurality of recesses includes a plurality of cradles, a plurality of upstanding members, and a top member. The plurality of cradles is configured to seat within a plurality of recesses of an ice cube tray. Each cradle is configured to fit snugly within a recess of an ice cube tray. The plurality of upstanding wall portions is coupled to each cradle. The top member couples the upstanding wall portions together. The top member may include a handle. The upstanding wall portions may be angled relative to a base wall of the cradles by an angle greater than 90 degrees. The top member may extend longitudinally to separate a first row of cradles and a second row of cradles. Each cradle may have a planar bottom surface and upstanding side walls that have a shape that is substantially similar to a contour of an ice cube recess. The planar bottom surface may be a solid surface.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A combination ice cube tray and ice cube lifter, comprising:
a tray having one or more recesses, each of which has a bottom wall and side walls that extend upwardly from and contiguously around the bottom wall for forming one or more ice cubes therein; and
a lifting device having
a base portion that includes one or more cradles configured to seat within the one or more recesses of the tray to seat against the bottom wall of each of the one or more recesses of the tray, with each of the one or more cradles being coupled to an upstanding member; and
a top member that couples to the upstanding members.

2. The combination of claim 1, wherein the base portion includes a plurality of cradles and the tray includes a plurality of recesses, with each cradle being coupled to an upstanding member and the top member joins the upstanding members together.

3. The combination of claim 2, wherein the top member includes a handle and the upstanding members are wall portions.

4. The combination of claim 3, wherein the upstanding wall portions are spaced from one another to define a longitudinal space therebetween, with the cradles being arranged in two rows and being spaced apart by the longitudinal space between the upstanding wall portions, and the recesses in the tray defining two rows that correspond in position with the spacing of the cradles.

5. The combination of claim 4, wherein the tray includes a center divider positioned between the two rows of recesses, with an opening extending through the center divider, said opening being positioned at a point along the length of the tray that corresponds to the position of the handle of the lifting device.

6. The combination of claim 5, wherein a plurality of trays are provided and a corresponding plurality of lifting devices are provided, with a lifting device being coupled to each tray such that each tray/lifting device combination is stackable upon another tray/lifting device combination, with the handle of the adjacent lifting device extending through the opening disposed in the adjacent tray such that the tray/lifting device combinations are stackable on top of each other.

7. The combination of claim 1, further comprising a strengthening rib positioned under the top member.

8. The combination of claim 6, wherein the tray has a center divider with a longitudinally extending channel, said channel sized to accept the rib when devices are stacked on top of each other.

9. The combination of claim 1, wherein the top member of the lifting device has a width and a length, and the tray has a center divider that has a width and a length substantially similar to that of the lifting device.

10. The combination of claim 8, wherein the width of the top member of the lifting device is wide enough to support an adjacent tray should the tray be positioned on the top member.

11. The combination of claim 1, wherein the upstanding members of the lifting device are substantially separated from each other until they mate with the top member.

12. The combination of claim 2, wherein the base portions of the lifting device are configured to seat snugly against and around the bottom wall of each recess within the tray such that liquid will not substantially flow under the base portions when the recesses are filled with a liquid.

13. A method for lifting ice cubes from a tray comprising:
providing a tray having a plurality of recesses, each of which has a bottom wall and upstanding side walls for forming an ice cube in each recess;
providing a lifting device having a plurality of cradles for seating against the bottom wall of each of the plurality of recesses and an upstanding member coupled to each cradle, said upstanding members being joined together at the top end thereof and forming a handle;
positioning the lifting device in the recesses such that the cradles fit snugly within each recess;
filling the recesses with a fluid;
freezing the fluid in the trays;
raising the lifting device out of the tray utilizing the handle to remove the ice cubes that are formed on each cradle.

14. An ice cube lifting device for use with an ice cube tray having a plurality of recesses comprising:
a plurality of cradles configured to seat within a plurality of recesses of an ice cube tray, each cradle being configured to fit snugly within a recess of an ice cube tray;
a plurality of upstanding wall portions, with a wall portion coupled to each cradle; and
a top member that couples the upstanding wall portions together.

15. The ice cube lifting device of claim 14, wherein the top member includes a handle.

16. The ice cube lifting device of claim 14, wherein the upstanding wall portions are angled relative to a base wall of the cradles by an angle greater than 90 degrees.

17. The ice cube lifting device of claim 14, wherein the top member extends longitudinally to separate a first row of cradles and a second row of cradles.

18. The ice cube lifting device of claim 14, wherein each cradle has a planar bottom surface and upstanding side walls that have a shape that is substantially similar to a contour of an ice cube recess.

19. The ice cube lifting device of claim 18, wherein the planar bottom surface is a solid surface.
